(19) United States
(12) Patent Application Publication
(10) Pub. No.: US 2011/0220840 A1
(43) Pub. Date: Sep. 15, 2011

(54) Fluid Viscosity and Heat Transfer Via Optimized Energizing of Multi-Walled Carbon Nanotube-Based Fluids

(76) Inventors: Jorge Alvarado, Bryan, TX (US); Paritosh Garg, Houston, TX (US); Charles P. Marsh, Urbana, IL (US)

(21) Appl. No.: 12/709,837

(22) Filed: Mar. 11, 2010

(51) Int. Cl. C09K 5/00; B82Y 30/00; B82Y 40/00

(52) U.S. Cl. 252/71; 977/742; 977/752; 977/840

(57) ABSTRACT

In select embodiments of the present invention, a method for optimizing thermal transfer capacity of a fluid employs multi-walled carbon nano-tubes (MWCNTs) and a surfactant such as Gum Arabic (GA), that are mixed into a fluid, such as water, according to a specific protocol and energized via ultrasound until a specified amount of total energy is applied. For select embodiments, the maximum demonstrated enhancement of an aqueous fluid in thermal conductivity is 20% and in convective heat Transfer is 32%. The thermal conductivity enhancement increased considerably at bulk temperatures greater than 24° C. The percentage enhancement in convective heat transfer in a tube increases with axial distance. The resultant optimized fluid is also described.

### STATEMENT OF GOVERNMENT INTEREST

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees. Please contact Bea Shahin at 217 373-7234.

### BACKGROUND

Managing high thermal loads has become critical, especially in the industrial, defense, transportation, and space sectors. Several potential improvements in thermal control technologies have been investigated. Conventional heat transfer techniques that rely on fluids like water, ethylene glycol, and mineral oils are popular because of simplicity. Conventional heat transfer systems used in applications like petrochemical, refining, and power generation are rather large and involve significant amounts of heat transfer fluids. In certain cooling applications, heat transfer systems with a small footprint are required. For these, there is a direct relationship between size and cost associated with both manufacturing and operation and a small footprint a design goal could be met by using fluids having enhanced thermal transfer characteristics. Improvements are available for existing heat transfer systems by simply enhancing performance of heat transfer fluids to increase capacity. Either approach, i.e., new design or retrofit, results in reduced heat exchanger surface area, lower capital costs, and higher efficiency for equivalent capacity. One method for improving thermal transfer capacity of fluids adds nano-particles of highly thermally conductive materials like carbon, metal, and metal oxides to improve thermal transfer. Nano-particles may be spherical, cylindrical or of more complex shapes such as a “sea star” and the like. Cylindrical carbon nano-particles are termed carbon nano-tubes (CNTs). One type of CNT is a multi-walled CNT (MWCNT), multiple concentric tubes in a single configuration.

A critical step in preparing carbon nano-fluids is dispersing CNTs in a base fluid. Due to the high aspect ratio of CNTs and strong Van der Waal's interaction forces between carbon surfaces leading to agglomeration or clumping, dispersion of CNTs in aqueous media is challenging. CNTs are hydrophobic, thus, when employed in “usable” concentrations, they are unable to be effectively dispersed in water under ambient conditions. Typically, two methods for dispersal are used: mechanical and chemical. Hilding, J. et al., Dispersion of Carbon Nano-tubes in Liquids, Journal of Dispersion Science and Technology 24 (1) 1-41, 2003. Mechanical methods generally include ultra-sonication using an ultrasonic probe with a bath or liquid medium. Chemical methods include using surfactants and CNT-functionalization using acids. Use of a surfactant changes the surface wetting or adhesion behavior, reducing the tendency to self-agglomerate (clump). CNT-functionalization can employ acids at high temperature, resulting in addition of polar groups, such as COOH or OH, typically at defect sites on the CNT surface. However, aggressive CNTs-functionalization can damage CNTs. Both mechanical and chemical methods may reduce the aspect ratio of CNTs. When adding energy to a CNT-based fluid, also termed a “nano-fluid,” such as done with ultra-sonication of the nano-fluid, accumulating energy to a threshold level may break CNTs, i.e., the aspect ratio is reduced. Thermal conductivity enhancement in fluids containing CNTs decreases with reduction in aspect ratio; therefore, proper care must be taken during processing to minimize breakage. Assael, M. J. et al., Thermal Conductivity of Suspensions of Carbon Nano-tubes in Water, International Journal of Thermophysics 25 (4), 971-985, 2004; Hamilton, R. L. and O. K. Crosser, Thermal Conductivity of Heterogeneous Two-Component Systems, IEC Fundamentals 1 (3) 187-191, 1962. In select embodiments of the present invention, a combination mechanical (ultra-sonication) and chemical (surfactant) method is employed. Surfactants are used to disperse CNTs in several cases. Some examples are sodium dodecyl sulfate (SDS) (Assael 2004), sodium dodecyl benzene sulfonate (SDBS) (Wen, D. and Y. Ding, Effective Thermal Conductivity of Aqueous Suspensions of Carbon Nano-tubes (Carbon Nanotube Nano-fluids), Journal of Thermophysics and Heat Transfer 18 (4) 481-485, 2004), and hexadecyltrimethyl ammonium bromide (CTAB) (Assael, M. J. et al., Thermal Conductivity Enhancement in Aqueous Suspensions of Carbon Multi-Walled and Double-Walled Nano-tubes in the Presence of Two Different Dispersants, International Journal of Thermophysics 26 (3) 647-664, 2005 and Nanosperse AQ (Assael 2005). SDBS failed at elevated temperatures (Wen 2004). Additionally, Gum Arabic (GA) was found to be a better surfactant than sodium dodecyl sulfate (SDS) and cetyltrimethylammoniumchloride (CTAC) for dispersing CNTs in de-ionized (DI) water (Bandyopadhyaya, R. et al., Stabilization of Individual Carbon Nano-tubes in Aqueous Solutions, Nano Letters 2 (1) 25-28, 2002). This has been confirmed via testing two samples of MWCNTs 1.0 wt % aqueous suspensions using GA and SDS each as sole surfactants. Suspensions prepared using GA have been visually observed to be more stable even after several weeks as compared to those prepared using SDS. However, GA has a tendency to increase viscosity when added to DI water, resulting in an increase in energy use for pumping within a heat transfer system. Thus, it is important to optimize the amount of GA employed to minimize viscosity to achieve efficient pumping while optimizing CNT dispersal. Viscosity is a limiting factor for both convective heat transfer and energy use. Experimental data for the effective viscosity of aqueous nano-fluids are available only for certain nano-particles, such as Al₂O₃ (Pak, B. C. and Y. L. Cho, Hydrodynamic and Heat Transfer Study of Dispersed Fluids with Submicron Metallic Oxide Particles, Experimental Heat Transfer 11 (2) 151-170, 1998; Das, S. K. et al., Pool Boiling Characteristics of Nano-Fluids, International Journal of Heat and Mass Transfer 46 (5) 851-862, 2003; Li, C. et al., Relationship Between Water Mobility and Viscosity of Nanometric Alumina Suspensions, Journal of the American Ceramic Society 88 (10) 2762-2768, 2005; and Heris, S. Z. et al., Experimental Investigation of Oxide Nano-fluids Laminar Flow Convective Heat Transfer, International Communications in Heat and Mass Transfer 33 (4) 529-535, 2006), CuO (Heris 2006, Kulkarni, D. P. et al., Temperature Dependent Rheological Property of Copper Oxide Nano-particles Suspension (Nano-fluid), Journal of Nanoscience and Nanotechnology 6 (4) 1150-1154, 2006), TiO₂ (Pak 1998) and Ding, Y. et al., Heat Transfer of Aqueous Suspensions of Carbon Nano-tubes (CNTs Nano-fluids), International Journal of Heat and Mass Transfer 49, 240-250, 2006). Most of these studies relate to metal oxide nano-particles. There is only one work that studied aqueous MWCNTs extensively (Ding 2006). Previously, viscosity has been investigated in regards to particle volume concentration, temperature and shear rate. Empirically derived and supported analytical models for prediction of the viscosity of high aspect ratio of nano-material additions (e.g., CNTs) to nano-fluids are not available. Previous studies focused on spherical nano-particles of metal oxides, and are based on the Einstein theory for viscosity that takes into account spherical particles. Einstein, A., Eine Neue Bestimmung der Molekuldimension, Annalen der Physik 19, 289-306, 1906. In the case of CNT-based nano-fluids, such models cannot correlate the experimental data well because the shape of a CNT does not satisfy the assumptions in the Einstein model.

Aqueous CNT-based nano-fluids exhibit shear thinning or pseudo-plastic type of non-Newtonian behavior. (Ding 2006). However, no report correlates empirical measurements of CNT nano-fluids with theoretical non-Newtonian viscosity models. The theoretical models provide equations that correlate shear stress of a flowing fluid to shear rate and are used to classify flow behavior of a new nano-fluid. The widely used models for non-Newtonian flow are Power Law, τ=K·\dot{y}ⁿ and Herschel Bulkley, τ=τ′+K·\dot{y}ⁿ, where τ, K,\dot{y}, τ′ and n are shear stress, flow consistency index, shear rate, yield shear stress and flow behavior index, respectively.

Prior to development of select embodiments of the present invention, the impact of processing time, or ultra-sonication time, on the viscosity of multi-walled CNTs (MWCNTs) aqueous nano-fluids had not been investigated. Development of select embodiments of the present invention allowed fitting experimental data to a shear stress-shear rate mathematical model.

The heat transfer characteristic of a flowing fluid can be represented by a Nusselt number, Nu, that accommodates the Prandtl number, including thermal conductivity. Thus, a first assessment of heat transfer potential measures thermal conductivity. There are many reports on metal oxide nano-fluids but few for CNT-based nano-fluids. Das (2003); Wen, D. S, and Y. L. Ding, Experimental Investigation into Convective Heat Transfer of Nano-fluids at Entrance Area under Laminar Flow Region, International Journal of Heat and Mass Transfer 47 (24) 5181-5188, 2004; Xuan, Y. M. and Q. Li, Investigation on Convective Heat Transfer and Flow Features of Nano-fluids, ASME Journal of Heat Transfer 125, 151-155, 2003. One of the first studies involving CNT-based nano-fluids was by Choi et al. Choi, S. U. S. et al., Anomalous Thermal Conductivity Enhancement in Nano-tube Suspensions, Applied Physics Letters 79 (14) 2252-225, 2001. Choi measured the effective thermal conductivity of MWCNTs dispersed in synthetic poly(α-olefin) oil and reported a thermal conductivity enhancement of 160% by including 1.0 vol % nano-tubes in oil. Subsequently, Xie et al. reported thermal conductivity enhancements for water, ethylene glycol and decene as base fluids. Xie, H. Lee et al., Nano-fluids Containing Multi-walled Carbon Nano-tubes and Their Enhanced Thermal Conductivities, Journal of Applied Physics 94 (8) 4967-4971, 2003.

Assael et al. (2004, 2005) reported on aqueous MWCNT nano-fluids with the surfactants SDS, CTAB and Nanosperse AQ™ used as dispersants. However, much less percent enhancement in thermal conductivity resulted as compared to Choi et al. (2001) who employed a mineral oil as the fluid. The maximum thermal-conductivity enhancement observed by Xie et al. (2003) was 20% for 1 vol % nano-tubes in decene, and that observed by Assael et al. (2004) was 38% for 0.6 vol % CNT in water. Wen and Ding (Wen et al. 2004) used SDBS as a dispersant and results were comparable to Xie et al. (2003) and Assael et al. (2004) and suggested that differences in interfacial thermal resistances and thermal conductivities of the CNTs used were the main reasons for the observed discrepancies with respect to Choi et al. (2001). The base fluid used by Choi et al. (2001) was poly-α-olefin (having a lower thermal conductivity than water). Though percentage enhancement reported was high, the absolute enhancement was not as high as expected. As SDBS was also found to fail at elevated temperatures, Ding et al. (2004) reported using GA as a dispersant, achieving a maximum enhancement of 79% with MWCNTs of 1 wt % in water.

Most reporting on MWCNT-based nano-fluids focuses on thermal conductivity enhancement as a function of nano-particle volume concentration, base fluid, and temperature. Effects of particle size (Assael et al. 2004, 2005); dispersant (surfactant) (Assael et al. 2004, 2005) and acidity (Ding et al. 2006) have also been considered. Assael et al. (2005) reported the effect of particle size indirectly by increasing the homogenization time by ultra-sonication, and concluded that when CNT suspensions are homogenized for long periods of time, their aspect ratio decreases, concomitantly decreasing thermal conductivity. Yang et al. (2006) conducted similar studies and reached analogous conclusions with oil dispersions. Yang, Y. et al., Thermal and Rheological Properties of Carbon Nanotube-In-Oil Dispersions, Journal of Applied Physics 99 1114307-1-8, 2006. However, no other studies confirm these findings.

Investigation of thermal conductivity enhancement in CNT dispersions is limited. Berber et al. (2000) report that CNT-based nano-fluids conduct current and heat ballistically (in a fast diffusive manner). Berber, S. et al., Unusually High Thermal Conductivity of Carbon Nano-tubes, Physical Review Letters 84 (20) 4613-4616, 2000. Ballistic conduction is associated with large mean-free paths of phonons in CNTs. Hence, CNTs promote faster heat diffusion in liquids. Furthermore, there is evidence that an organized solid structure at the interface with a liquid is a potential governing mechanism in heat conduction from a solid wall to an adjacent liquid. Ohara, T. and D. Suzuki, Intermolecular Energy Transfer at a Solid-Liquid Interface, Nanoscale and Microscale Thermophysical Engineering 4 (3) 189-196, 2000. It has been postulated (Choi et al. 2001) that this organized solid/liquid interface facilitates a favorable heat transport across the interface. Further, Jang and Choi postulated another theory using Brownian motion of nano-particles as a potential mechanism for increased thermal conductivity of nano-fluids at elevated temperatures. Jang, S. P. and S. U. S. Choi, Role of Brownian Motion in the Enhanced Thermal Conductivity of Nano-fluids, Applied Physics Letters 84 (21) 4316-4318, 2004. They suggested that as temperature is increased, the viscosity of base fluids is decreased and Brownian motion of nano-particles is consequently increased. It has been postulated that convection-like effects are induced by Brownian motion, resulting in increased effective thermal conductivity. However, Keblinski et al. reported that Brownian motion is unlikely to have a direct role in enhancement of thermal conductivity. Keblinski., P. et al., Mechanisms of Heat Flow in Suspensions of Nano-Sized Particles (Nano-fluids), International Journal of Heat and Mass Transfer 45 (4) 855-863, 2002. Wen and Ding (2004) suggested the formation of CNT networks as one of the likely mechanisms that facilitates avenues for faster diffusion and potential ballistic transport of energy carriers. From the above, it is difficult to ascertain a single definitive mechanism for enhancing thermal conductivity.

The practical heat transfer utility of a nano-fluid is best identified by its convective heat transfer coefficient. Past research has focused on thermal conductivity, while overlooking the importance of convective heat transfer. Only a few papers have been written on convection, and most focused on metal oxide nano-particles (Pak et al. (1998); Das et al. (2003); Wen et al. (2004) and Xuan et al. (2003)). Only two papers have presented results from testing MWCNT aqueous suspensions under constant heat flux and laminar flow conditions. Faulkner et al. reported convective heat transfer enhancement in a micro-channel at very low Reynolds numbers (2-17) and particle volume concentrations between 1.1-4.4 vol %. Faulkner, D. J. et al., Enhanced Heat Transfer Through the Use of Nano-fluids in Forced Convection, Proceedings of IMECE, Anaheim, USA, 2004. Ding et al. (2006) reported heat transfer enhancement at intermediate Reynolds numbers (800-1200) and low particle volume concentration (as low as 0.95 vol %). Although both reported heat transfer enhancement, the heat transfer enhancement trends with respect to particle volume concentration in one contradicted the other. Both considered parametric effects of particle volume concentration, Reynolds number and heat flux, however, neither ultra-sonication time nor particle size reduction was considered. Research in this area has been limited, thus theoretical models for heat transfer enhancement have not been developed fully.

### BRIEF DESCRIPTION OF DRAWINGS

FIG. 1 is a schematic of the experimental configuration used to measure a convective heat transfer coefficient for select embodiments of the present invention.

FIGS. 2A-D are TEM photos of MWCNTs at 1.0 wt % in samples A, B, C and D, respectively, at a scale of 0.5 μm, under in-situ conditions.

FIG. 2E-F are TEM photos of samples B and D, respectively, at a scale of 200 μm, under in-situ conditions.

FIGS. 3A-B are line graphs representing the viscosity of samples A-D, DI water, and water with gum Arabic (GA) at 0.25 wt %, at 15° C. and 30° C., respectively.

FIG. 4A is a line graph representing an index, K (mPa/sec) versus time of ultra-sonication for four samples, 2 employing MWCNTs at 1.0 wt % at 15° C. and 30° C., respectively and two employing GA 0.25 wt % at 15° C. and 30° C., respectively.

FIG. 4B is a line graph representing flow consistency index, n, versus time of ultra-sonication for four samples, 2 employing MWCNTs at 1.0 wt % at 15° C. and 30° C., respectively and two employing GA 0.25 wt % at 15° C. and 30° C., respectively.

FIG. 5 is a line graph representing percent conductivity enhancement versus temperature for samples A-D.

FIGS. 6A-C are line graphs representing axial variation of heat transfer coefficients at: Re=600, 900, and 1200, respectively.

FIG. 7 is a microscopic photo of sample B at a resolution of 100 μm.

FIGS. 8A-C are line graphs representing axial variation of percentage enhancement in heat transfer coefficient and change in fluid bulk temperature at Re=600, 900 and 1200, respectively.

FIG. 9 is a line graph representing variation of an experimental Nusselt number with axial distance at Re=600±100.

FIGS. 10A-D are line graphs representing percentage enhancement of the heat transfer coefficient with Reynolds number for Samples A-D, respectively, at four fixed axial distances.

### DETAILED DESCRIPTION

In select embodiments of the present invention, nano-fluids are prepared by dispersing MWCNTs in water for use as enhanced heat transfer fluids. The appendix provides definitions of acronyms, symbols and nomenclature used herein. Several investigators established that suspending CNTs in conventional heat transfer fluids enhances thermal conductivity and convective heat transfer (Assael et al. (2004, 2005), Wen et al. (2004), Ding et al. (2006) and Choi et al. (2001)). Preparation and processing conditions impact the physical properties and thermal performance of CNTs aqueous nano-fluids and thus must be optimized as done with select embodiments of the present invention to achieve an efficient final product.

In select embodiments of the present invention, a method for optimizing thermal transfer capacity of a fluid comprises providing a pre-specified amount of carbon nano-tubes (CNTs) of a pre-specified range of sizes, a pre-specified amount of a surfactant such as Gum Arabic (GA), a pre-specified amount of the fluid; mixing the pre-specified amount of GA into the fluid, resulting in a first solution; mixing the pre-specified amount of CNTs into the first solution, resulting in a second solution; providing a pre-specified amount of energy, such as via sonicating, to the second solution for a first pre-specified period; mixing the energized second solution for a second pre-specified period; and repeating the last two steps for a pre-specified number of iterations until a pre-specified total amount of energy is delivered to the second solution, resulting in a fluid optimized for thermal transfer capacity.

In select embodiments of the present invention a pre-specified amount of surfactant provided as GA is between about 0.1 wt % and 0.5 wt % of the second solution. In select embodiments of the present invention the pre-specified amount of GA is about 0.25 wt % of the second solution.

In select embodiments of the present invention the fluid is water. In select embodiments of the present invention the fluid is de-ionized water.

In select embodiments of the present invention the CNTs is multi-walled CNTs (MWCNTs). In select embodiments of the present invention the pre-specified amount of MWCNTs is between about 0.5 wt % and 1.5 wt % of the second solution. In select embodiments of the present invention the pre-specified amount of MWCNTs is about 1.0 wt % of the second solution.

In select embodiments of the present invention the MWCNTs have a diameter of approximately 10 nm to approximately 20 nm, a length of approximately 0.5 microns to approximately 40 microns and a purity of approximately 95%. In select embodiments of the present invention the MWCNTs clusters when mixed with the GA, the clusters being of a size between about 10 and about 20 microns.

In select embodiments of the present invention the first pre-specified period is in the range of about 3 minutes to about 10 minutes. In select embodiments of the present invention the second pre-specified period is in the range of about 3 minutes to about 10 minutes.

In select embodiments of the present invention the number of iterations is between about 3 and about 15. In select embodiments of the present invention the first pre-specified period is in the range of about 5 minutes. In select embodiments of the present invention the number of iterations is about 7.

In select embodiments of the present invention the second pre-specified period is about 5 minutes. In select embodiments of the present invention the number of iterations is about 7.

In select embodiments of the present invention the second solution is sonicated with a probe operating at a frequency between about 10 KHz and about 30 KHz at an amplitude of between about 50% and about 100% at a power level between about 100 W and about 150 W. In select embodiments of the present invention the second solution is sonicated with a probe operating at a frequency of about 20 KHz at about 100% amplitude at a power level of about 130 W.

In select embodiments of the present invention a fluid is optimized for thermal transfer capacity by the method described above. In select embodiments of the present invention, a fluid optimized for thermal transfer capacity comprises: a pre-specified amount of carbon nano-tubes (CNTs) of a pre-specified range of sizes, a pre-specified amount of a surfactant such as Gum Arabic (GA), a pre-specified amount of a base fluid; a first solution established by mixing the pre-specified amount of surfactant into the base fluid; a second solution established by mixing a pre-specified amount of a CNTs into the first solution such that in a first step, the second solution is energized, such as by ultrasound, for a first pre-specified period and in a second step, the energized second solution is mixed for a second pre-specified period and the first and second steps are repeated for a pre-specified number of iterations, resulting in a fluid optimized for thermal transfer capacity.

De-ionized (DI) water, Gum Arabic (GA) and MWCNTs were used to produce aqueous suspensions. The MWCNTs were procured from Helix Material Solutions Inc, USA. The MWCNTs, produced by chemical vapor deposition (CVD) process, had a specified average outside diameter of approximately 10 to approximately 20 nm, length of approximately 0.5 microns to approximately 40 microns and purity of approximately 95%. GA fine powder was supplied by Biochemika. Four 500 g samples of MWCNTs/GA-enhanced fluid were prepared with characteristics, total sonication times and energy provided per sample given in Table 1. GA was dissolved in DI water using a magnetic stirrer and MWCNTs was added to the GA-based solution. The resulting composition for each sample was submitted to ultrasound (ultra-sonicated) for five minutes at 100% amplitude using a 130 W ultra-sonication probe at 20 kHz (Sonics & Materials, Inc, USA). Since the probe operates within a limited conical volume, uniform dispersion was assured by five minutes of magnetic stirring after the five minutes of ultra-sonication. The ultra-sonication and magnetic stirring process were alternated every five minutes until each sample had been sonicated for the desired amount of time (20, 40, 60 or 80 minutes for Samples A-D, respectively). Based on processing time, a fixed amount of energy was transferred to each sample. This energy was divided by the mass of the sample (500 g) to obtain specific energy, e, transferred to each sample. It was assumed that all the energy imparted was received by each sample. The samples prepared by this technique were found to be stable for over one month with no visible sedimentation or settling.

TABLE 1
Test Samples.

| | Wt % | | | |
|---|---|---|---|---|
| Sample | MWCNTs | Wt % GA | Time (min) | Energy (J/g) |
| A | 1.0 | 0.25 | 20 | 57 |
| B | 1.0 | 0.25 | 40 | 113 |
| C | 1.0 | 0.25 | 60 | 188 |
| D | 1.0 | 0.25 | 80 | 290 |

One of the limitations of conventional transmission electron microscopy (TEM) is that test samples have to be dried and exposed to vacuum before they can be imaged. This may induce structural changes in the sample introducing doubt as to the dried sample being representative of the original. To overcome this, a new type of TEM technique, termed “wet-TEM” was used. Franks R., et al., A Study of Nanomaterial Dispersion in Solution by Wet-Cell Transmission Electron Microscopy, Journal of Nanoscience and Nanotechnology 8 (1-4), 2008; U.S. patent application Ser. No. 12/365,698, Reusable Sample Holding Device Permitting Ready Loading of Very Small Wet Samples, by Marsh et al., filed Feb. 2, 2009, incorporated herein by reference. Wet-TEM allows imaging of samples under wet or in-situ conditions without altering original condition. The new technique allows imaging to capture the quality of MWCNTs dispersion.

A JEOL 2010 LaB6 TEM was used with a beam acceleration voltage of 200 KeV. A wet-cell was constructed by confining fluid between two silicon nitride membrane window TEM grids. The grids contained a 200 μm thick frame and a 50 nm thick window, in which the sample was placed. The grids were then placed in a custom-built TEM sample holder described in the '698 patent application.

Viscosity was measured using a low viscosity rotational type viscometer (LVDV-I Prime, Brookfield Engineering Laboratories, Inc., USA). This model has a maximum torque rating of 6.737×10⁻⁵ N-m and a specified accuracy of ±1%, verified using a Brookfield standard viscosity test fluid. A combination of a cylindrical sample container and spindle, termed a UL Adapter, was used to measure low viscosity. The viscous drag experienced by the spindle of the UL Adapter is factory calibrated to display dynamic viscosity on a digital output screen. Measurements were taken at several shear rates at 15° C. and 30° C., respectively.

Thermal conductivity was measured using a KD 2 Pro thermal properties analyzer (Decagon Devices, Inc., USA). The instrument has a probe of 60 mm length and 1.3 mm diameter and includes a heating element, a thermistor and a microprocessor to control and measure conduction with a specified accuracy of ±5%. The instrument is based on the working principle of a transient hot wire method. Assael et al. (2004, 2005); Ding et al. (2006), and Alloush, A. et al., A Transient Hot Wire Instrument for Thermal Conductivity Measurements in Electrically Conductivity Instruments in Elevated Temperatures, International Journal of Thermophysics 3 (3) 225-235, 1982. Samples were maintained at specified temperatures using a temperature-controlled chiller. A number of measurements were taken for each sample and the mean calculated for only those measurements with a correlation coefficient, R², greater than 0.9995.

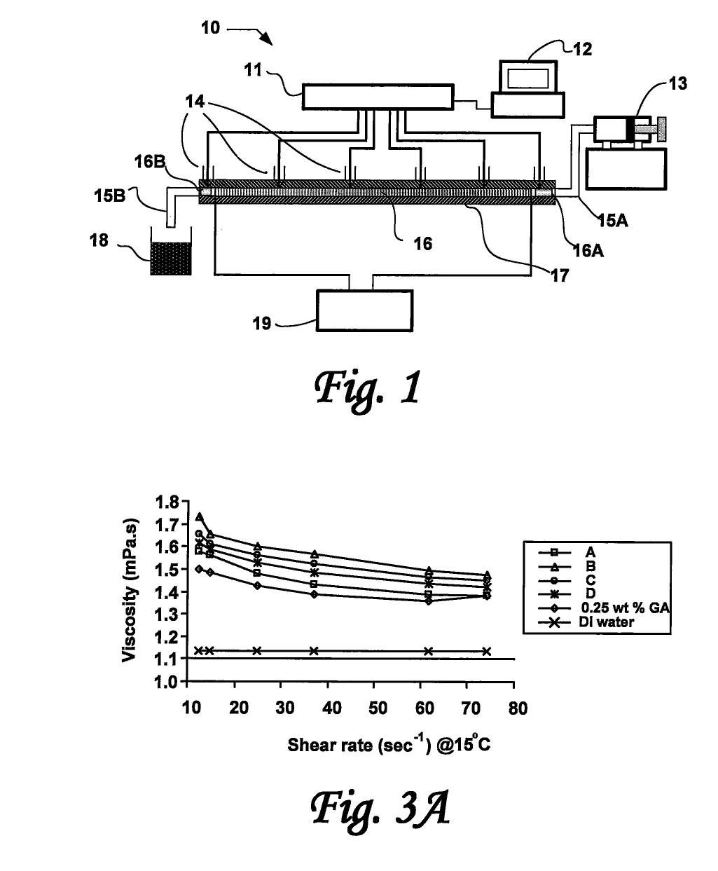

Refer to FIG. 1, the experimental configuration 10 used to measure convective heat transfer coefficient for select embodiments of the present invention. The configuration 10 is calibrated to ±5% accuracy. Major components comprise a copper heat transfer section 16, data acquisition system 11, a D.C. power supply 19, a syringe metering pump 13 and a computer 12. A 914.4 mm long straight copper tube 16, of 1.55 mm inner diameter and 3.175 mm outer diameter was used as a test section. The copper tube 16 was heated by an AWG 30 nichrome 80 wire 17 (MWS wire industries, USA) wound on the tube 16 and connected to a 1500 W, 0-300V, 0-5 A D.C. power supply 19 (Lambda, U.S.A.). Both ends of the copper tube 16 were connected to well-insulated plastic tubing 15A, 15B to insulate the heat transfer section 16 and fluid (not shown separately) from axial heat conduction. Experiments were run under constant heat flux conditions using a current of 0.2 A. Four surface-mount thermocouples 14 were mounted on the copper tube 16 at axial positions of 19 cm, 39.5 cm, 59 cm and 79 cm from the inlet of the copper tube 16 to measure wall temperatures. Additionally, two thermocouples 14 were mounted on individual, unheated, and thermally insulated, short copper tubes 16A, 16B located before and after the heat transfer tube 16 to measure fluid bulk temperature at the inlet and outlet of the heated tube 16. Fluid was collected in a thermally insulated cup 18 after passing through the heat transfer section 16 where temperature was measured under mixing cup conditions to validate the outlet bulk fluid temperature measured by a thermocouple. A Cole Palmer syringe metering pump 13 was used with flow rates of 40, 60 and 80 mL/min, maintaining laminar flow. The corresponding Reynolds numbers for water at these flow rates are approximately 600, 900 and 1200, respectively. The thermocouples 14 and output from the D.C. power supply 19 were connected to a data acquisition system 11 (Agilent 34970A), in turn connected to a computer 12. The configuration 10 was calibrated both under isothermal and constant heat flux operating conditions, and correction factors were applied to all measurements.

The convective heat transfer coefficient, h(x), at an axial distance, x, from an inlet is defined as:

$$h ( x ) = \frac{{q}_{s}^{′}}{{T}_{s} ( x ) - {T}_{b} ( x )} \qquad ( 1 )$$

where:

qₛ′=heat flux applied to the fluid;

Tₛ(x)=wall temperature at a distance, x, from the inlet

T_{b}(x)=fluid bulk temperature at a distance, x, from the inlet

From the energy balance equation, the bulk temperature of the fluid, T_{b}(x), at an axial distance, x, can be found using:

$${T}_{b} ( x ) = {T}_{b , i} + \frac{{q}_{s}^{′} P}{{mc}_{p}} x \qquad ( 2 )$$

where:

T_{b,i}=fluid bulk temperature at the inlet;

T_{b,o}=fluid bulk temperature at the outlet;

P=perimeter of the copper tube;

x=axial distance from the inlet of the test section;

m=mass flow rate of the fluid; and

cₚ specific heat of the fluid

The heat flux applied to the fluid (qₛ′) is determined from:

$${q}_{s}^{′} = \frac{{mc}_{p} ( {T}_{b , 0} - {T}_{b , i} )}{A} \qquad ( 3 )$$

The convective heat transfer coefficient is also defined in the form of a Nusselt number, Nu, as:

$$Nu ( x ) = \frac{h ( x ) \cdot {D}_{i}}{k} \qquad ( 4 )$$

where:

Dᵢ=inside diameter of the copper tube, and

k=thermal conductivity of the test fluid

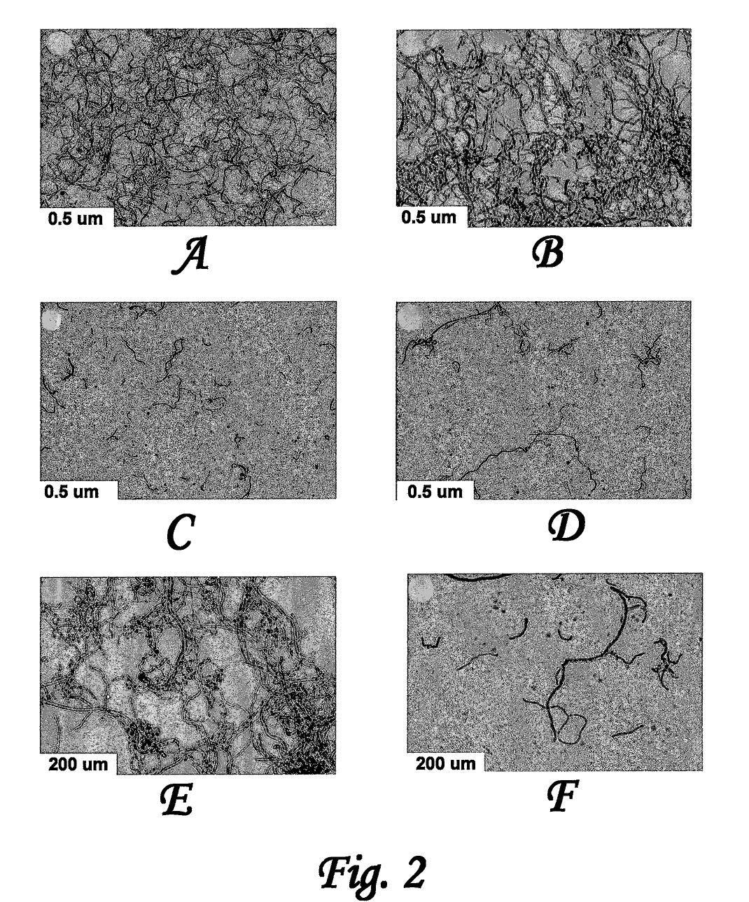

FIG. 2A-D are TEM photos of samples A, B, C and D, respectively, at a scale of 0.5 μm, under in-situ conditions, using a wet-TEM technique described in Franks et al. (2008) and the '698 patent application. Samples A and B exhibit a good three-dimensional network of CNTs. Samples

C and D show shorter CNTs attributed to the additional ultra-sonication time. FIGS. 2E and 2F, both at a scale of 200 nm, depict the photos of FIGS. 2B and 2D, respectively. The length of the MWCNTs of sample D is less than those of sample B. Though the images may not represent all nano-fluid samples, they indicate damage caused from extensive ultra-sonication. The images also show that viscosity and thermal conductivity respond to the amount of energy delivered via ultra-sonication as further discussed below.

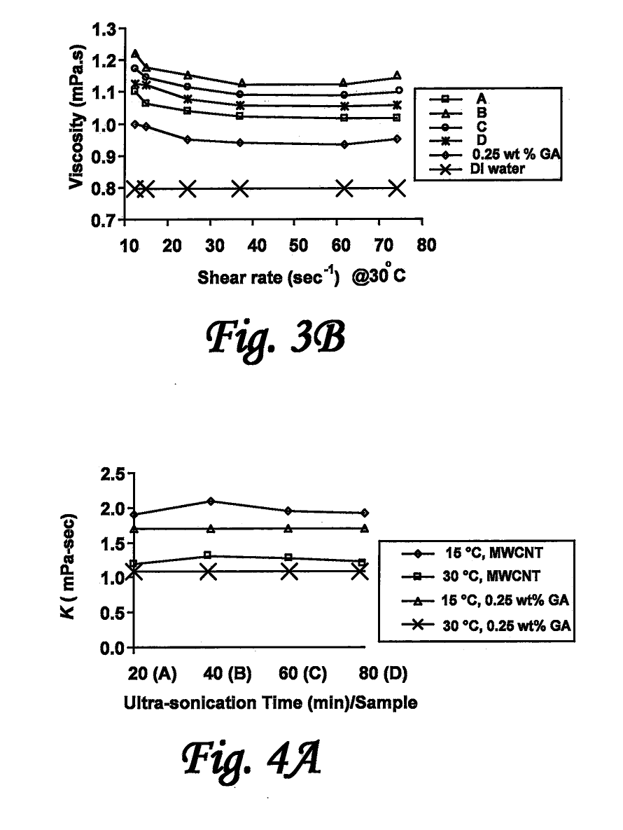

A rotating drum viscometer (not shown separately) was used to measure dynamic viscosity and shear rate. Refer to FIGS. 3A and 3B showing variation of viscosity with shear rate for each of the samples A-D (MWCNTs and 0.25 wt % GA) and also DI water and a GA 0.25 wt % aqueous solution at 15° C. and 30° C., respectively. The MWCNTs/GA-based aqueous nano-fluids displayed a non-Newtonian behavior, especially at 15° C. A shear thinning or pseudo-plastic behavior was observed resulting in a decrease in viscosity with an increase in shear rate up to 60 sec⁻¹. For the GA 0.25 wt % aqueous solution, shear thinning was observed initially (up to 60 sec⁻¹) but a slight shear thickening was observed at 75 sec⁻¹. A shear thinning effect may be explained by possible de-clumping of bundled MWCNTs or realignment in the direction of the shearing force, resulting in less viscous drag. A slight shear thickening may be attributed to the unique fluid properties of GA dispersions that have shown both shear thinning and shear thickening behavior at different shear rates in recent studies. Sanchez, C., et al., Structure and Rheological Properties of Acacia Gum Dispersions, Food Hydrocolloids, 16 257-267, 2002.

Viscosity of the MWCNTs/GA suspension first increased from sample A (20 min) to sample B (40 min), and thereafter decreased with increase in ultra-sonication time. Starr et al. found that a clustered CNTs suspension shows lower viscosity than a dispersed suspension. Starr, F. W., et al., Origin of Particle Clustering in a Simulated Polymer Nano-Composite and Its Impact on Rheology, Journal of Chemical Physics 119 (3), 1777-1788, 2003. The increase in viscosity in a dispersed sample is due to increased attractive surface interactions as a result of greater surface-to-volume ratio. Starr (2003). For a fully dispersed sample, an exposed CNTs surface has a greater number of nano-particles than in a clustered sample, resulting in greater viscosity. Due to less applied dispersing energy for sample A, the MWCNTs may not have received enough energy to overcome clumping and thus remained clustered. Sample B was sonicated for twice as long, receiving optimum energy to create a uniform dispersion, thus increasing viscosity. Viscosity decreased continuously with sonication time longer than 40 minutes as is evident with Samples C and D. Further, MWCNTs “strands” broke with an increase in ultra-sonication time as may be observed by comparing FIGS. 2A and 2B with FIGS. 2C and 2D. Excessive ultra-sonication results in reduced MWCNTs length and aspect ratio. Although a lower viscosity is preferable for achieving optimum energy savings, the reduction in length and aspect ratio of the MWCNTs reduces thermal performance, thus optimization in preparing a nano-fluid requires balancing the viscosity of the resultant fluid with the aspect ratio of the MWCNTs and this is done in select embodiments of the present invention by selecting an optimized sonication/mixing schedule. Yang (2006) discovered that as ultra-sonication of a CNTs-in-oil dispersion is increased, viscosity decreases. This is explained as the disruption of a 3-D network of CNTs with a decrease in aspect ratio of the CNTs. This reasoning is confirmed in the TEM photos of FIGS. 2A-F.

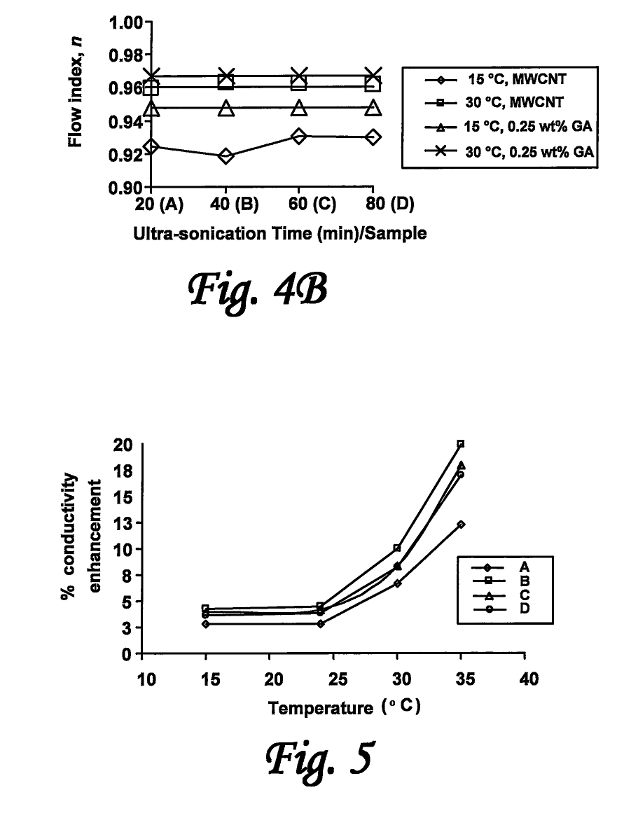

From the above, non-Newtonian behavior is affirmed. Quantitative assessment correlates shear stress and shear rate by curve fitting. Refer to FIGS. 3A and 3B. Plots of shear stress vs. shear rates were made for each MWCNTs/GA sample (A-D) as well as the GA 0.25 wt % sample. The empirically derived mathematical relation found for each sample was compared with the viscosity models discussed above to establish characteristic flow behavior for sample B, the optimum sample established under the above experiment. The MWCNTs/GA samples (A-D) followed the Power Law (τ=K·\dot{γ}ⁿ) viscosity model. The R² value (correlation coefficient) for each was more than 0.999, good correlation even for a slight shear thickening at 75 sec⁻¹. Flow consistency index, K, has the same units as viscosity, thus values of K are indicative of the relative magnitude of viscosity for a non-Newtonian fluid. The values for K and flow behavior index, n, were found for each MWCNTs/GA sample (A-D) as well as the GA 0.25 wt % sample at 15° C. and 30° C., respectively, as shown in FIGS. 4A and 4B. K increases with the ultra-sonication time from sample A to B and thereafter decreases. This is in agreement with the viscosity trend observed in FIGS. 3A and 3B that also show viscosity change of DI water for comparison. Values for the GA 0.25 wt % aqueous solution were lower than those of all the MWCNTs/GA samples (A-D) for both temperature regimes (15° C. and 30° C.).

Referring to FIG. 4B, the flow behavior index, n, at 30° C. remains almost constant with increasing ultra-sonication time. Since a low value of n indicates a more pronounced non-Newtonian behavior, a greater degree of non-Newtonian behavior is exhibited at lower temperature. However, at both temperatures (15° C. and 30° C.), the GA 0.25 wt % aqueous solution has a higher value of n than all MWCNTs/GA samples (A-D), indicating less non-Newtonian behavior. Therefore, the non-Newtonian behavior in MWCNTs/GA samples is due to the presence of MWCNTs, not GA.

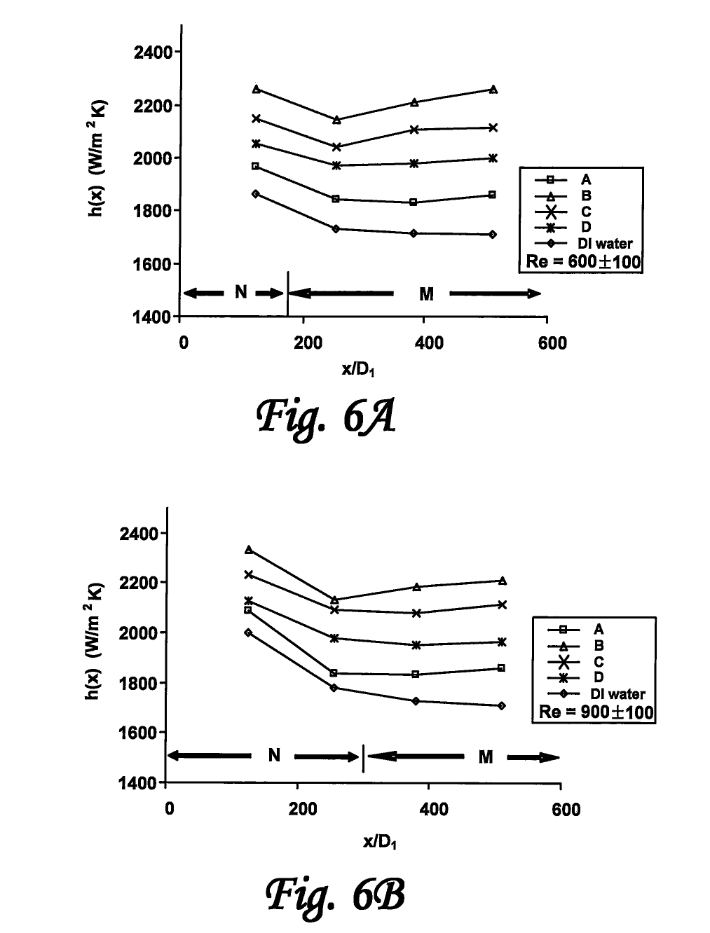

Measurements were taken at different temperatures for all the MWCNTs/GA (A-D) and GA samples and included DI water for comparison. All measurements for DI water were found to be within ±2% of established NIST values. Because GA added to water produced an insignificant change in thermal conductivity, water was used as the fluid for comparison. Refer to FIG. 5. Thermal conductivity increases slightly until the temperature exceeds 24° C., whereupon it increases non-linearly. A suggested reason for this phenomenon is increased Brownian motion. Jang (2004) suggests that as temperature increases, viscosity decreases, resulting in an increase in Brownian motion of nano-particles. This initiates convection effects that result in enhanced thermal conductivity. Referring to FIG. 5, a maximum increase of 20% in thermal conductivity was obtained for Sample B at 35° C. with samples C and D close thereto, indicating that a specifically established amount of sonication time above 20 minutes (applied to Sample A) is advised to optimize thermal conductivity. The average vendor-claimed density of MWCNTs is 2.1 g/cm³. Thus, a 1.0 wt % MWCNTs suspension is approximately 0.47 vol %. The percentage enhancement reported by Xie (2003) is 7% at MWCNTs 1.0 vol % (for an aspect ratio of approximately 2000) and that by Assael (2004) is 38% at MWCNTs 0.6 vol % (for an aspect ratio of approximately 500). Both Xie (2003) and Assael (2004) used higher mass fractions of MWCNTs than used in the above experiments, with no GA, and enhancement from the above work is much better than Xie (2003) and less than that of Assael (2004). Assael (2004) used a slightly higher volume fraction of MWCNTs than in the above experiments but much lower than Xie (2003), thus there may be a region in between 0.47 vol % and 1.0 vol % that results in optimized thermal conductivity. Improvements in thermal conductivity reported by Ding (2006) (i.e., 79% at MWCNTs 1.0 wt % at 30° C.) is much higher than those of the above experiments, even considering the concentration of CNTs used is the same as Xie (2003). The exact reason for this discrepancy is unclear. It may be due to differences in the thermal and physical properties of the CNTs used. Additionally, Ding (2006) did not specify the CNTs aspect ratio, and it could be different from the aspect ratio (approximately 50-2000) used in the experiments of Xie (2003) and Assael (2004).

From FIG. 5, it can be inferred that thermal conductivity enhancement is affected by ultra-sonication time, reaching an optimum for sample B at 40 min. This phenomenon may be associated with the aspect ratio of MWCNTs and the quality of the 3D network established within the samples. The aspect ratio of MWCNTs decreased with ultra-sonication exposure time after 40 min. This is evident in FIGS. 2E and 2F where samples B and D are compared at the 200 nm scale. Assael (2004) concluded that a decrease in aspect ratio decreases thermal conductivity enhancement. Further, Wen (2004) suggested CNTs networking as one of the factors contributing to enhanced thermal conductivity as it provides avenues for ballistic or fast heat transport. Sample A shows slightly lower thermal conductivity enhancement because there was not sufficient ultra-sonication time (energy applied) to uniformly disperse the MWCNTs. Sample B received sufficient energy for the creation of a uniform and effective 3D network of MWCNTs. Optimum conditions at the set wt % of MWCNTs were established in sample B, yielding an optimal aspect ratio and a uniform 3D network.

For heat transfer experiments, a constant heat flux was maintained at 0.6 W/cm². The Reynolds numbers (Re) for DI water were found to be approximately 600, 900 and 1200, respectively, at the three values of laminar flow employed. The presence of GA at 0.25 wt % in water resulted in an insignificant change in the heat transfer coefficient of water in laminar flow conditions; thus, DI water was used for comparison. The viscosity of the MWCNTs/GA samples changed appreciably with temperature and shear rate (due to non-Newtonian behavior, as noted above). The Re for each of these samples varied within ±100.

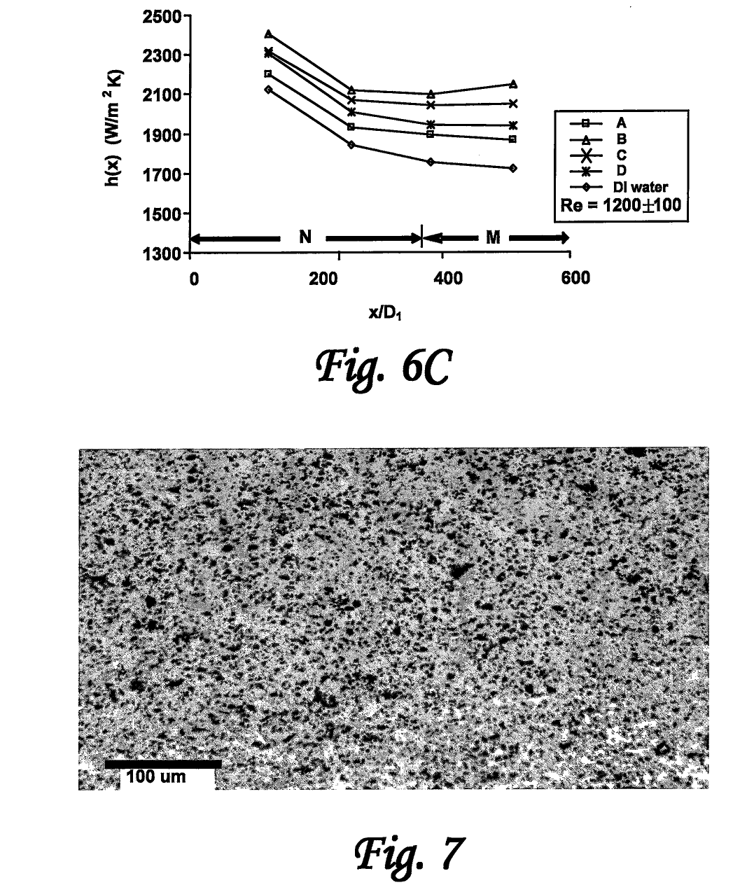

Refer to FIGS. 6A-C showing the variation of convective heat transfer coefficient for Samples A-D and DI water with respect to non-dimensionalized axial distance, x/Dᵢ, at various Re. Also indicated is the thermal entry length region for DI water, N, and thermally fully developed region for DI water, M. This shows the laminar heat transfer coefficient decreasing with axial distance, x. This is expected due to the known “entry length” phenomenon. For a purely Newtonian fluid flowing through a tube with circular cross section, the flow is considered to be hydrodynamically fully developed at x/Dᵢ≧(0.05·Re) and thermally fully developed at x/Dᵢ(0.05 Re Pr). Once the flow has become fully developed, the heat transfer coefficient value stabilizes for purely Newtonian fluids. A similar trend is observed for MWCNTs/GA samples to a certain extent. A clear enhancement in heat transfer coefficient is shown in FIGS. 6A-C upon comparing each of the MWCNTs/GA Samples (A-D) to DI water.

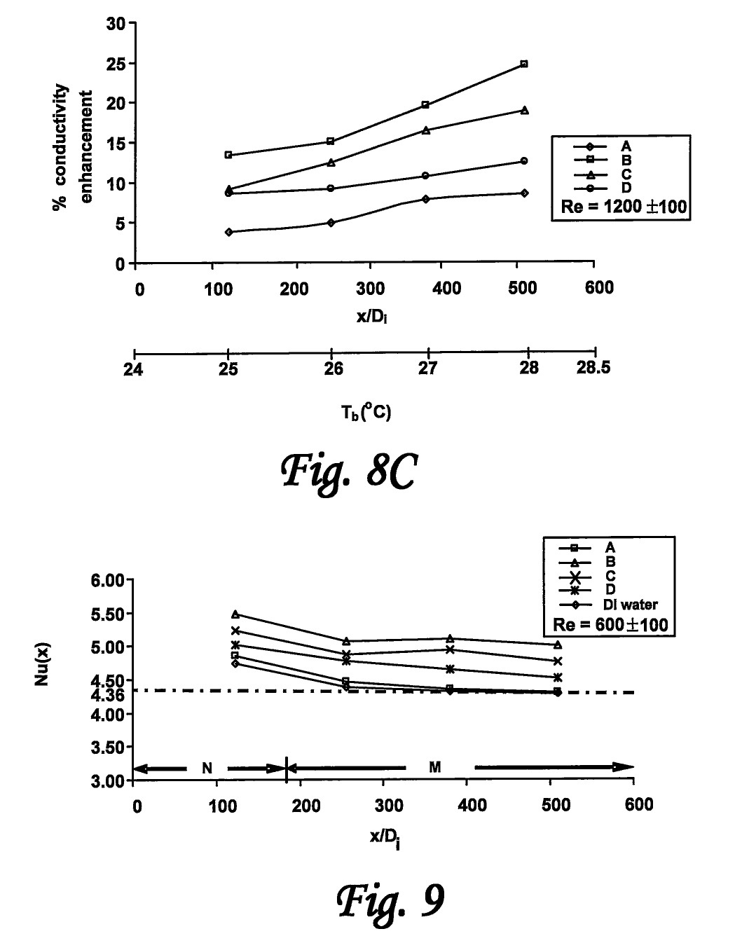

Refer to FIGS. 8A-C. Note that as axial distance, x, increases the temperature increases, decreasing viscosity. In FIG. 8A, note the enhancement with the convective heat transfer coefficient increasing continuously with axial distance, after initially falling, with the maximum increase found to be 32% (as compared to DI water) for sample B at Re=600±100. Refer to FIG. 5. This increase is more than the maximum increase of 20% in thermal conductivity for sample B. Ding (2006) reported a dramatic increase in heat transfer coefficient enhancement at 0.5 wt % CNTs, i.e., 375%, as compared to thermal conductivity enhancement, i.e., 37%. Similar results were reported by Wen (2004) and Xuan (2003). Wen (2004A) reported a heat transfer coefficient enhancement of 47%, and thermal conductivity enhancement of 10% at a 1.6 vol % of Al₂O₃ spherical nano-particles in DI water. Xuan (2003) reported a heat transfer coefficient enhancement of 60%, and thermal conductivity enhancement of 12.5% at a 2.0 vol % of Cu spherical nano-particles. Heat transfer coefficient enhancement has been found to be significantly greater than thermal conductivity enhancement from the above experiments of Wen (2004) and Xuan (2003). Ding (2006) posited several mechanisms for this. Using convective heat transfer fundamentals, Ding (2006) stated that the heat transfer coefficient, h, can be approximately represented as k/δₜ, k and δₜ, are the thermal conductivity of the test fluid and thickness of the thermal boundary layer, respectively. With an increase in k and/or a decrease in δₜ, or δ, the value of h should increase. A simultaneous decrease in δor δₜ may cause the observed heat transfer enhancement. Physically, this may be due to boundary layer thinning, most likely caused by the CNTs. However, in a fully developed laminar flow region, δₜ and δ are not expected to change appreciably, thus one or more other enhancement mechanisms may apply.

Sohn and Chen discovered that for a liquid comprising solid micro-scale particles, thermal conductivity enhancements under shear conditions are greater than those observed under static conditions. Sohn, C. W. and M. M. Chen, Micro-convective Thermal Conductivity in Dispersed Two Phase Mixture as Observed in a Low Velocity Couette Flow Experiment, Journal of Heat Transfer, Trans. ASME 103 47-51, 1981. This phenomenon was attributed to micro-convective effects due to the presence of an eddy-type convection mechanism. Significant enhancements were seen for samples having a Peclet number greater than 300, where Peclet number, Pe, is defined as

$$\frac{{{γ}^{\overline{.}}}_{f} \cdot {d}_{p}^{2}}{{α}_{f}}$$

where {dot over ( γ̅_{f}, dₚ and α_{f} are local mean shear rate experienced by fluid, particle diameter and thermal diffusivity of the fluid, respectively. Additionally, Ahuja found that significant enhancements were seen in thermal conductivity in tube flow when the Ahuja number, defined as

$$φ \cdot \frac{ω {a}^{2}}{{v}_{f}} \cdot \frac{ω {a}^{2}}{{α}_{f}} \cdot {( \frac{R}{a} )}^{2} \cdot ( \frac{L}{2 a} ) \times {10}^{- 8} ,$$

Doublet Collision Frequency ratio, where φ, ω, α, ν_{f}, R and L are particle volume fraction, angular velocity of particles, particle radius, kinematic viscosity, tube radius and heated length, respectively; has a value near 0.02. Ahuja, A. S., Augmentation of Heat Transfer in Laminar Flow of Polystyrene Suspensions II, Analysis of the Data, Journal of Applied Physics 46 (8) 3417-3425, 1975.

The difference between these reports is that Sohn (1981) is based on couette flow whereas Ahuja (1975) is based on poiseuille flow. However, both reported that enhancement was due to the inertia of entrained fluid rotating with the particles.

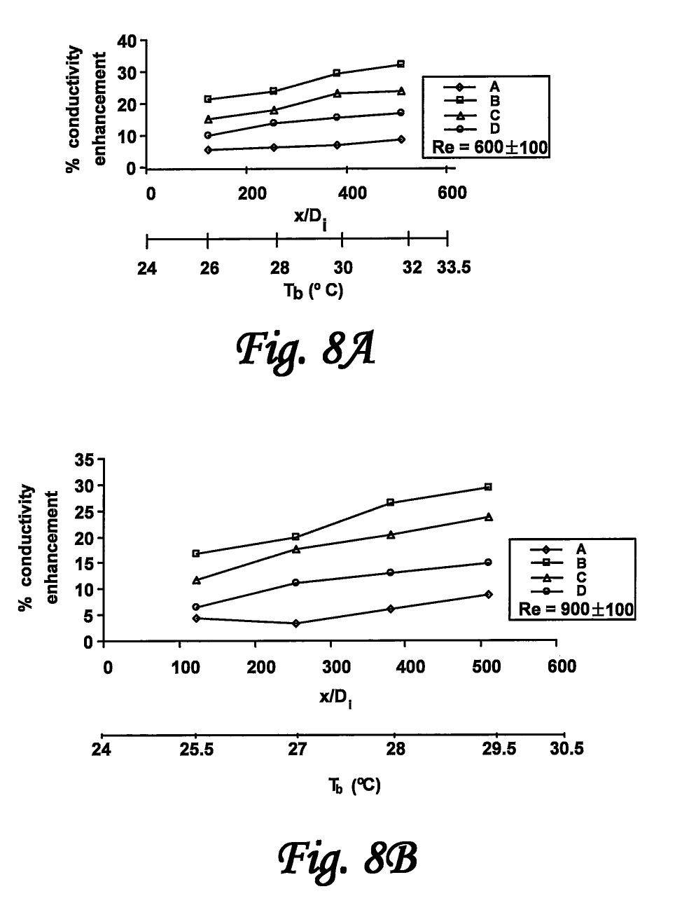

Refer to FIG. 7, a microscopic photo of a drop of sample B. The MWCNTs, as mixed with GA, macroscopically exist as clusters of a size in the range between about 10 and about 20 microns. This is much less than the particle size of 2.9 mm and 0.3 mm used by Sohn (1981) and the 50 and 100 micron particles used by Ahuja (1975). Further, the particle volume fractions used by Sohn and Ahuja (1975) were greater than those used in developing select embodiments of the present invention, i.e., 0.47 vol %. The Peclet number as defined by Sohn (1981) and the Ahuja Number of Ahuja (1975) were calculated based on specified cluster sizes (10-20 μm), particle volume fractions, and flow conditions. The Peclet number (in the range of 0.5 to 2.5) and Ahuja number (in the range of 10⁻⁶ to 10⁻⁷) are well below values at which significant enhancement, as possibly explained by micro-convection, may be expected. Therefore, in view of reduced thermal conductivity enhancement, a micro-convective effect is not a major reason for heat transfer enhancement.

Refer to FIGS. 3A-B and 5. MWCNTs in fluid may be re-arranged due to non-uniform shear rate in the radial direction. The viscosity of MWCNTs-enhanced fluids decreases with shear rate up to a maximum and thermal conductivity increases with temperature after a certain minimum temperature is exceeded. Thus viscosity and thermal conductivity as experienced in the radial direction is dependent on both temperature and shear rate. Wen and Ding showed previously that such a change could result in a high Nusselt number yielding a higher heat transfer coefficient. Wen, D. S, and Y. L. Ding, Effect on Heat Transfer of Particle Migration in Suspensions of Nano-Particles Flowing Through Mini-Channels, Microfluidics and Nano-fluidics 1 (2) 183-189, 2005.

Thermal convection is enhanced if viscosity near the wall of a tube is decreased with respect to the viscosity of the bulk fluid. Kamil, W., Heat Transfer in Temperature-Dependent Non-Newtonian Flow, Chemical Engineering and Processing 43 1223-1230, 2004. In a tube, temperature at the wall is a maximum and at the centerline is a minimum. Due to this temperature gradient, viscosity varies in the radial direction, resulting in a minimum at the wall and maximum at the centerline. This leads to enhanced convection in the radial direction, improving the heat transfer coefficient. Kamil (2004). Further, Gingrich et al. found that non-Newtonian fluids have a higher Nu than Newtonian fluids. A fluid with fluid behavior index, n, less than one (indicating shear thinning behavior) exhibits higher heat transfer than one with n equal to unity. Since CNTs-based fluids exhibit a shear thinning behavior, a non-Newtonian behavior may be a major mechanism of improved heat transfer enhancement as compared to thermal conductivity enhancement. Gingrich, W. K. et al., Effect of Shear Thinning on Laminar Heat Transfer Behavior in a Rectangular Duct, International Journal of Heat and Mass Transfer 35 (11) 2823-2836, 1992.

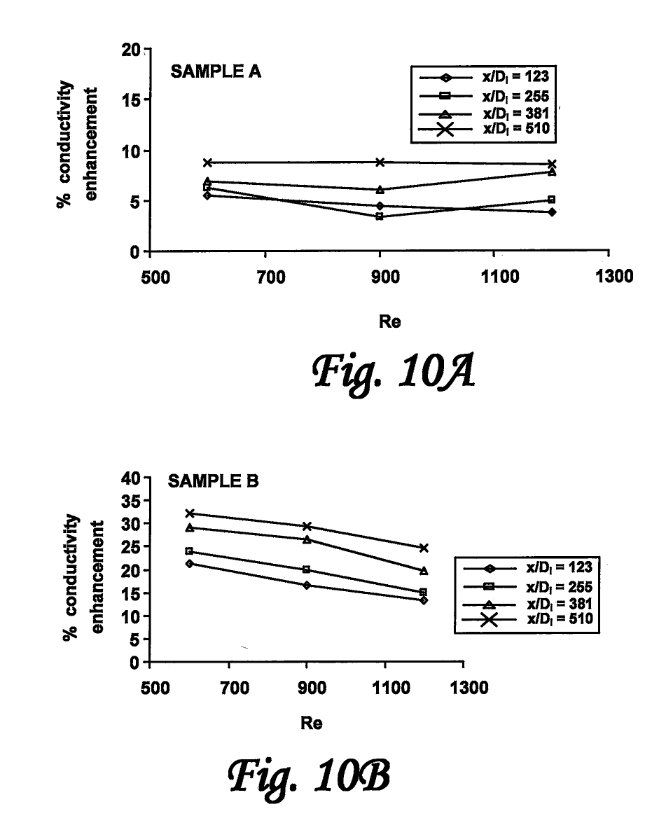

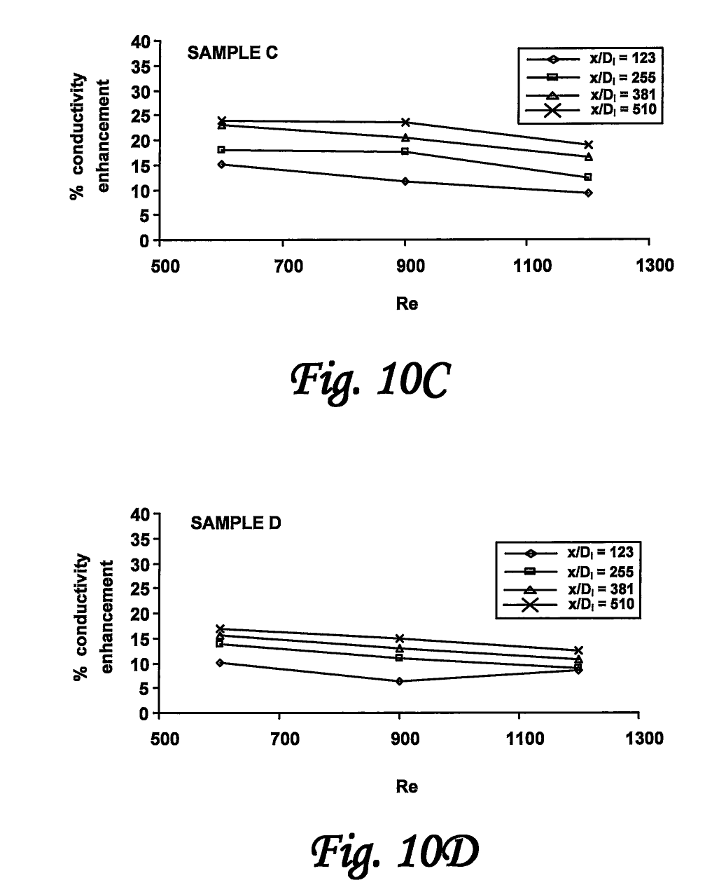

Ding (2006) observed that the enhancement of a heat transfer coefficient reached a maximum for a certain value of x/Dᵢ. However, referring to FIGS. 8A-C and 9, the experiments used in developing select embodiments of the present invention show that the percentage enhancement increases continuously with axial distance. The bulk temperature of the Samples A-D increases with axial distance, resulting in a significant increase in the thermal conductivity of the samples with axial distance, coupled with thermal conductivity increases associated with temperature increases as shown in FIG. 5. Since the heat transfer coefficient is directly proportional to thermal conductivity in laminar flow (Eqn. 4), a slight increase in heat transfer coefficient results. In addition to measuring the heat transfer coefficient, the local Nu was calculated for each sample to determine the net heat transfer enhancement in a non-dimensionalized way using Eqn. 4. The corresponding thermal conductivity values for Samples A-D were calculated by linear interpolation from FIG. 4B after considering the bulk temperature from FIGS. 8A-C and 9. Nu values for Re=600±100 are shown in FIG. 9. The experimental Nu for DI water matched well with the theoretical fully-developed Nu value of 4.36 for a constant heat flux case. Further, from the Nu calculations, a heat transfer enhancement is evident.

FIGS. 8A-C show variations for heat transfer coefficient enhancement with Reynolds number (Re) for Samples A-D. The enhancement decreases with an increase in Re from 600 in FIG. 8A to 900 in FIG. 8B and to 1200 in FIG. 8C and a decrease in temperature from FIG. 8A to FIG. 8C. This decrease in enhancement may be associated with the decrease in bulk temperature of the MWCNTs/GA-enhanced fluid with increase in Re. It is known that thermal conductivity enhancement has considerable dependence on the bulk temperature of the CNTs-enhanced fluid. A decrease in bulk temperature reduces thermal conductivity enhancement and results in a slight decrease in heat transfer enhancement. Further, from the plots of FIGS. 8A-C and 9, ultra-sonication exposure time affects heat transfer enhancement with Sample B having been exposed for a time within the optimum range for the given MWCNTs and GA mix percentage. Also, Sample B performs best at all three values of Re, although the lowest Re (most laminar flow) is optimum. A similar trend was seen in thermal conductivity data, and may be associated with the aspect ratio of MWCNTs and quality of the 3D network established within each of the samples, as described above.

As can be deduced from the above discussion, proper preparation of MWCNTs-enhanced fluids is important in optimizing heat transfer performance. With a given MWCNTs-based composition, there is a range of optimum processing conditions that yields maximum enhancement. Ultra-sonication has a two-fold effect on MWCNTs-enhanced fluids. Below the optimum processing time, ultra-sonication increasingly aids in forming better dispersions, however, once the optimum time has been reached, further ultra-sonication results in breaking the MWCNTs, reducing the aspect ratio. For the type and concentration of MWCNTs used in the above experiments, optimum ultra-sonication time is about 40 minutes at an MWCNTs concentration of about 1.0 wt % with a surfactant, such as GA at about a 0.25 wt % concentration, using a 130 W, 20 kHz ultra-sonicator.

Viscosity of MWCNTs-enhanced fluids increases with sonication time until a maximum and decreases thereafter. The initial increase is associated with de-clustering of MWCNTs bundles, resulting in better dispersion. Any decrease in viscosity is due to breakage of MWCNTs, resulting in shorter MWCNTs, reduced aspect ratio, and inferior 3D networking.

The maximum thermal conductivity enhancement was obtained for an ultra-sonication time of 40 minutes, and was found to decrease with further sonication. The initial increase was explained by formation of a better 3D network in the samples, and the latter decrease was explained by a decrease in the aspect ratio of MWCNTs.

Maximum percentage enhancement in the heat transfer coefficient was 32% at Re=600±100 as observed in Sample B (FIG. 8A). The percentage enhancement in heat transfer coefficient, h(x), at a particular axial distance was found to slightly decrease with an increase in Re. The percentage enhancement in heat transfer coefficient, h(x), was found to continuously increase with axial distance after an initial decrease. The maximum percentage enhancement in heat transfer coefficient, h(x), is more than the maximum percentage enhancement in thermal conductivity.

The abstract of the disclosure is provided to comply with the rules requiring an abstract that will allow a searcher to quickly ascertain the subject matter of the technical disclosure of any patent issued from this disclosure. (37 CFR §1.72(b)). Any advantages and benefits described may not apply to all embodiments of the invention.

While the invention has been described in terms of some of its embodiments, those skilled in the art will recognize that the invention can be practiced with modifications within the spirit and scope of the appended claims. For example, although the system is described in specific examples for MWCNTs/GA-enhanced fluids, it may be used for producing any type of CNTs-enhanced fluids that may be useful in such diverse applications as automotive cooling, refrigeration, heating, industrial cooling and heating, and the like. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Thus, it is intended that all matter contained in the foregoing description or shown in the accompanying drawings shall be interpreted as illustrative rather than limiting, and the invention should be defined only in accordance with the following claims and their equivalents.

### APPENDIX

### Nomenclature

K flow consistency index, mPa·s
n flow behavior index
N rotational speed, rpm
k fluid thermal conductivity, W/m-° C.
x axial distance from the inlet of the test section, m
h convective heat transfer coefficient, W/m²-° C.
qₛⁿ: heat flux applied to the fluid, W/m²
Tₛ surface temperature, ° C.
T_{b} fluid bulk temperature, ° C.
P inner perimeter of the copper tube, m
\dot{m} mass flow rate, Kg/sec
c_{P} Fluid specific heat, KJ/Kg-° C.
A inner surface area of the copper tube, m²
Dᵢ inside diameter of copper tube, m
Nu Nusselt number
e specific energy, J/Kg
dₚ particle diameter, m or μm
u Fluid velocity, m/s
L Heated length, cm
a Particle radius, cm
Pr Prandtl number
Re Reynolds number,

$$\frac{ρ \cdot {uD}_{i}}{μ}$$

Pe Peclet number,

$$\frac{{{γ}^{\overline{.}}}_{f} \cdot {d}_{p}^{2}}{{α}_{f}}$$

### Greek Symbols

τ Shear stress, N/m²
\dot{γ} Shear rate, sec⁻¹
τ′ Yield shear stress, N/m²
μ Fluid viscosity, mPa·s
δ hydrodynamic boundary layer thickness, m
δₜ Thermal boundary layer thickness, m
{dot over ( γ̅_{f} Local mean shear rate experienced by fluid, sec⁻¹
α_{f} Fluid thermal diffusivity, m²/s
ρ Fluid density, Kg/m³
φ Particle volume fraction
ω Angular velocity of particle, rad/sec
ν_{f} Kinematic viscosity, cm²/s

### Subscripts

p particle
s surface
b bulk
i inlet
o outlet
f fluid

We claim:

1. A method for optimizing thermal transfer capacity of a fluid, comprising:
a) providing a pre-specified amount of carbon nano-tubes (CNTs) of a pre-specified range of sizes;
b) providing a pre-specified amount of a surfactant;
c) providing a pre-specified amount of said fluid;
d) mixing said pre-specified amount of surfactant into said fluid, resulting in a first solution;
e) mixing said pre-specified amount of said CNTs into said first solution, resulting in a second solution;
f) providing a pre-specified amount of energy to said second solution for a first pre-specified period;
g) mixing said energized second solution for a second pre-specified period; and
h) repeating steps f) and g) for a pre-specified number of iterations until a pre-specified total amount of energy is applied, resulting in said fluid optimized for thermal transfer capacity.

2. The method of claim 1 providing said pre-specified amount of surfactant as Gum Arabic (GA) at between about 0.1 wt % and about 0.5 wt % of said second solution.

3. The method of claim 2 providing said pre-specified amount of GA at about 0.25 wt % of said second solution.

4. The method of claim 1 providing said fluid as water.

5. The method of claim 1 providing said fluid as de-ionized water.

6. The method of claim 1 providing said CNTs as multi-walled CNTs (MWCNTs).

7. The method of claim 6 providing said pre-specified amount of MWCNTs at between about 0.5 wt % and about 1.5 wt % of said second solution.

8. The method of claim 6 providing said pre-specified amount of MWCNTs at about 1.0 wt % of said second solution.

9. The method of claim 6, providing said MWCNTs having a diameter of approximately 10 nm to approximately 20 nm, a length of approximately 0.5 microns to approximately 40 microns and a purity of approximately 95%.

10. The method of claim 6, providing said MWCNTs that, when mixed with said GA, form clusters that are of a size between about 10 microns and about 20 microns.

11. The method of claim 1, providing said pre-specified amount of energy via ultra-sonication and establishing said first pre-specified period in the range of about 3 minutes to about 10 minutes.

12. The method of claim 11, establishing said second pre-specified period in the range of about 3 minutes to about 10 minutes.

13. The method of claim 11, establishing said number of iterations between about 3 and about 15.

14. The method of claim 11, establishing said first pre-specified period in the range of about 5 minutes.

15. The method of claim 14, establishing said number of iterations at about 7.

16. The method of claim 11, establishing said second pre-specified period of about 5 minutes.

17. The method of claim 16, establishing said number of iterations at about 7.

18. The method of claim 11, sonicating said second solution with a probe operating at a frequency between about 10 KHz and about 30 KHz at an amplitude of between about 50% and about 100% at a power level between about 100 W and about 150 W.

19. The method of claim 11, sonicating said second solution with a probe operating at a frequency of about 20 KHz at about 100% amplitude at a power level of about 130 W.

20. A fluid mixture optimized for thermal transfer capacity, said fluid mixture made by the method of claim 1.

21. A fluid mixture optimized for thermal transfer capacity, comprising:
a pre-specified amount of carbon nano-tubes (CNTs) of a pre-specified range of sizes;
a pre-specified amount of a surfactant;
a pre-specified amount of fluid;
a first solution established by mixing said pre-specified amount of surfactant into said pre-specified amount of fluid; and
a second solution established by mixing said pre-specified amount of said CNTs into said first solution in a first step, energizing said second solution for a first pre-specified period in a second step, mixing said energized second solution for a second pre-specified period, and repeating said first and second steps for a pre-specified number of iterations to yield a pre-specified cumulative amount of energy applied to said second solution.

22. The fluid mixture of claim 21 in which said pre-specified surfactant is Gum Arabic (GA) at an amount between about 0.1 wt % and about 0.5 wt % of said second solution.

23. The fluid mixture of claim 22 in which said pre-specified amount of GA is about 0.25 wt % of said second solution.

24. The fluid mixture of claim 21 in which said fluid is water.

25. The fluid mixture of claim 21 in which said fluid is de-ionized water.

26. The fluid mixture of claim 21 in which said CNTs are multi-walled CNTs (MWCNTs).

27. The fluid mixture of claim 26 in which said pre-specified amount of MWCNTs is between about 0.5 wt % and about 1.5 wt % of said second solution.

28. The fluid mixture of claim 26 in which said pre-specified amount of MWCNTs is about 1.0 wt % of said second solution.

29. The fluid mixture of claim 26 in which said MWCNTs have a diameter of approximately 10 nm to approximately 20 nm, a length of approximately 0.5 microns to approximately 40 microns and a purity of approximately 95%.

30. The fluid mixture of claim 26 in which said MWCNTs, when mixed with said GA, form clusters of a size between about 10 microns and about 20 microns.

31. The fluid mixture of claim 21 in which said pre-specified amount of energy is provided via ultra-sonication and said first pre-specified period is from about 3 minutes to about 10 minutes.

32. The fluid mixture of claim 31 in which said second pre-specified period is from about 3 minutes to about 10 minutes.

33. The fluid mixture of claim 31 in which said number of iterations is between about 3 and about 15.

34. The fluid mixture of claim 31 in which said first pre-specified period is about 5 minutes.

35. The fluid mixture of claim 34 in which said number of iterations is about 7.

36. The fluid mixture of claim 31 in which said second pre-specified period is about 5 minutes.

37. The fluid mixture of claim 36 in which said number of iterations is about 7.

38. The fluid mixture of claim 31 in which said second solution is sonicated with a probe operating at a frequency between about 10 KHz and about 30 KHz at an amplitude of between about 50% and about 100% at a power level between about 100 W and about 150 W.

39. The fluid mixture of claim 31 in which said second solution is sonicated with a probe operating at a frequency of about 20 KHz at about 100% amplitude at a power level of about 130 W.
